(19) United States
(12) Patent Application Publication
(10) Pub. No.: US 2017/0124365 A1
(43) Pub. Date: May 4, 2017

(54) REAL-TIME LOCATING SYSTEM-BASED BIDIRECTIONAL PERFORMANCE IMAGING SYSTEM

(71) Applicant: INDUSTRIAL BANK OF KOREA, Seoul (KR)

(72) Inventors: Pilsoon SHIN, Busan (KR); Jongman Kwon, Gwangju-si (KR)

(21) Appl. No.: 14/926,682

(22) Filed: Oct. 29, 2015

(51) Int. Cl. G06K 7/10; H05B 37/02; H04N 7/18; H04N 5/232; G01S 3/786

(52) U.S. Cl. CPC G06K 7/10425; H04N 5/23206; G01S 3/7864; H04N 7/181; H05B 37/0272

(57) ABSTRACT

A real-time locating system (RTLS)-based bidirectional performance imaging system is provided. The system detects a position of a performer in real time during a performance by the performer and automatically controls lighting and a performing image according to the detected position. The system includes a tag possessed by a performer; and one or more access points installed in one position of a performance venue. A position of the tag is measured by the one or more access points.

### BACKGROUND

1. Field of the Invention

The present invention relates to a real-time locating system (RTLS)-based bidirectional performance imaging system, and more particularly, to a system for controlling lighting and a performance image by tracking a position of a performer in real time using a tag possessed by the performer and an access point installed in a performance venue.

2. Discussion of Related Art

Generally, a relation between a performer, lighting, and a background image, etc. is configured according to a detailed arrangement in a performance such as a concert, a musical, etc. For example, such an arrangement may include that a performer be located at a specific position in a performance venue and that lighting illuminate the specific position with a specific effect in a specific scene.

This is due to the lack of technology capable of controlling lighting in real time according to a position of a performer.

Since the performer's actions are limited to those agreed upon in advance, there is a limitation on an activity range of the performer, and particularly, there is a problem that liveliness is decreased since there is a limitation on extemporaneous stage performance of the performer, and it is not possible to cope with unexpected behavior or mistakes, etc. of the performer.

A conventional patent document (Korean Patent Publication No. 10-2009-0069637) discloses an attempt to solve the problem described above by easily controlling lighting on a stage, but this is only a temporary solution as technology for making lighting control easier.

### SUMMARY OF THE INVENTION

The present invention is directed to a real-time locating system (RTLS)-based bidirectional performance imaging system capable of detecting a real-time position during a performance of a performer, and automatically controlling lighting, a performing image, etc. according to the detected real-time position.

According to one aspect of the present invention, there is provided an RTLS-based performance system, including: a tag possessed by a performer; and one or more access points installed in one position of a performance venue, wherein a position of the tag is measured by the one or more access points.

Further, the system may further include: one or more lighting devices configured to be controlled according to the position of the performer which is measured by the tag and the one or more access points.

The one or more lighting devices may be controlled to perform at least one of a tracking operation, an on/off operation, or a dimming operation.

Further, the system may further include: one or more cameras configured to track the performer according to the position of the performer which is measured using the tag and the one or more access points.

Moreover, the system may further include: one or more motion recognition cameras configured to recognize a motion of the performer.

One or more of the motion recognition cameras may be selected according to the position of the performer which is measured using the tag and the one or more access points.

The system may further include: a display unit configured to display an image generated from the images obtained by the one or more cameras or the one or more motion recognition cameras.

When the number of performers is one or more, the performers may be identified by tag IDs.

According to another aspect of the present invention, there is provided an RTLS-based performance method.

The method may include: measuring a position of a tag by one or more access points using the tag possessed by a performer, the one or more access points being installed in one position in a performance venue.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a schematic diagram illustrating a performance system according to one embodiment of the present invention;

FIG. 2 is a schematic diagram illustrating a performance system according to one embodiment of the present invention;

FIG. 3 is a schematic diagram illustrating a performance system according to one embodiment of the present invention;

FIG. 4 is a schematic diagram illustrating a performance system according to another embodiment of the present invention;

FIG. 5 is a schematic diagram illustrating a performance system according to still another embodiment of the present invention; and

FIG. 6 is a flowchart for describing a performance method according to still another embodiment of the present invention.

### DETAILED DESCRIPTION OF EXEMPLARY EMBODIMENTS

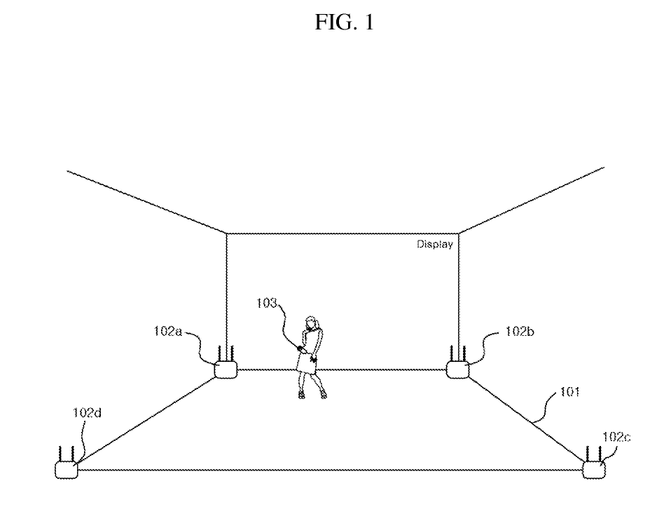

FIG. 1 is a schematic diagram illustrating a performance system according to one embodiment of the present invention.

Referring to FIG. 1, a system may include a tag 103 possessed by a performer; and one or more access points 102a, 102b, 102c, and 102d installed in one position of a performance venue, and a position of the tag 103 may be measured by the one or more access points 102a, 102b, 102c, and 102d.

General position confirmation or measurement systems include the Global Positioning System (GPS), an inertial navigation system (INS), a long range aid to navigation (LORAN), a radio frequency identification/ubiquitous sensor network (RFID/USN), a method of utilizing a wireless communication network, etc. Among them, a “wireless positioning system,” which is a method of using a wireless communication network, may serve the purpose of measuring a precise position of a terminal by a method such as a cell-identification (ID), time of arrival (ToA), time difference of arrival (TDoA), angle of arrival (AoA), or a fingerprint, etc. using code division multiple access (CDMA), orthogonal frequency division multiplexing (OFDM), a wireless local area network (WLAN), infrared rays, ultrasonic waves, Bluetooth, radio frequency identification (RFID), ultra wideband (UWB), etc. in real time, and technology development for wireless positioning systems is being actively performed together with technology concentration of Internet of things (IoT).

In the wireless positioning system, particularly, a UWB-based positioning method may be local area high speed data transmission technology which is based on UWB of the Institute of Electrical and Electronics Engineers (IEEE) 802.15.3a and is capable of transmitting multimedia data with low power through a wide bandwidth equal to or more than 500 MHz, and when compared with technology based on a conventional wireless fidelity (Wi-Fi) signal and Bluetooth signal, there may be an advantage that a precise distance can be measured at an ultrahigh speed and a cost can be lowered while power consumption is decreased.

The UWB-based wireless positioning method may be performed according to a two-way ranging (TWR) method of calculating a round trip time (RTT) between the access point and the UWB tag and converting the calculated RTT into a distance, and a TDoA method of calculating a distance by simultaneously measuring signal arrival times of signals transmitted from the access points which are synchronized to the tag, and as a result, a signal exchange time between the access point and the tag may be a basis of the UWB-based wireless positioning method.

In the present invention, the wireless positioning method by the tag and the one or more access points may include any method using CDMA, OFDM, a WLAN, infrared rays, ultrasonic waves, Bluetooth, RFID, UWB, etc., and preferably, may be the wireless positioning method based on UWB.

In the present invention, the position of the tag may be found by utilizing the one or more access points by the method described above. That is, the position of the performer possessing the tag in the performance venue may be found.

The number and positions of the one or more access points 102a, 102b, 102c, and 102d are only an example, and are not limited thereto. Preferably, the number of the one or more access points 102a, 102b, 102c, and 102d may be 4, and the one or more access points 102a, 102b, 102c, and 102d may be positioned at edge portions.

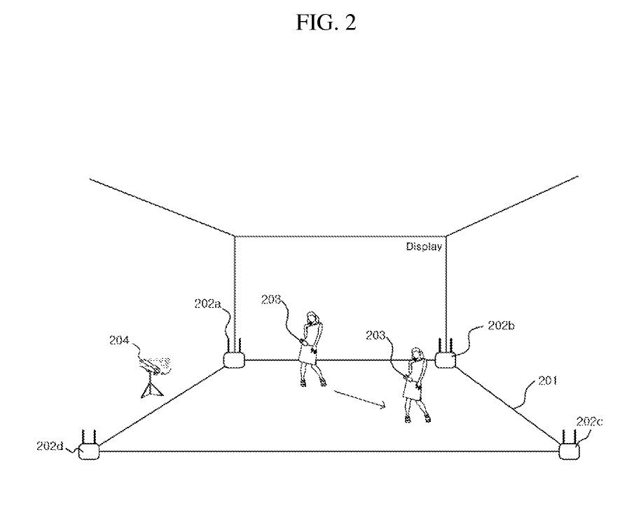

FIG. 2 is a schematic diagram illustrating a performance system according to one embodiment of the present invention.

Referring to FIG. 2, a system may further include one or more lighting devices 204 controlled according to a position of a performer which is measured by a tag 203 and one or more access points 202a, 202b, 202c, and 202d.

As shown in FIG. 2, the performer possessing the tag 203 may move along an arrow from an initial position, and it may be found that the performer possessing the tag 203 has moved from the initial position to a next position by the positioning method.

For example, the lighting device 204 may continuously illuminate the performer by tracking the performer possessing the tag 203 when the position change of the performer possessing the tag 203 is found.

Accordingly, even when the performer possessing the tag 203 freely moves in the performance venue, the lighting device 204 may continuously track the performer without separate control.

A control unit (now shown) of the lighting device 204 may control the lighting device 204 to track the performer possessing the tag 203 by finding the position of the performer possessing the tag 203.

The control of the control unit may include an operation of tracking the lighting device 204, and also include an on/off operation, a dimming operation, etc.

An example in which the number of lighting devices 204 is 1 is illustrated in FIG. 2, but this is only an example, and the number of lighting devices 204 may be one or more.

The control unit may control the one or more lighting devices 204 according to a position of the performer possessing the tag 203 in the performance venue 201.

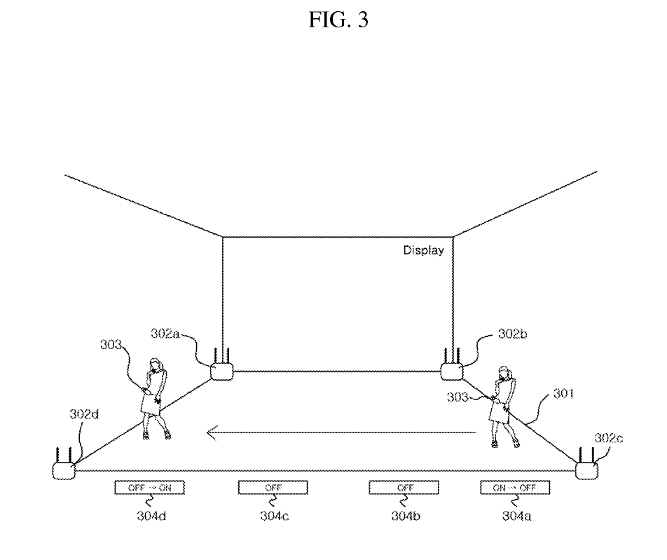

FIG. 3 is a schematic diagram illustrating a performance system according to one embodiment of the present invention.

Referring to FIG. 3, a system may further include one or more cameras 304a, 304b, 304c, and 304d for tracking the performer according to a position of the performer which is measured by a tag 303 and one or more access points 302a, 302b, 302c, and 302d.

The one or more cameras 304a, 304b, 304c, and 304d may be one or more motion recognition cameras for recognizing a motion of the performer possessing the tag 303.

For example, the motion recognition camera may be Kinect, and may project an interactive performing image.

A portion of the one or more motion recognition cameras 304a, 304b, 304c, and 304d may be selected and operated according to the position of the performer measured by the tag 303 and the one or more access points 302a, 302b, 302c, and 302d.

For example, as shown in FIG. 3, when the performer possessing the tag 303 moves from the initial position to the next position, the initial position of the performer possessing the tag 303 may be found using the tag 303 and the one or more access points 302a, 302b, 302c, and 302d, the first camera 304a covering the position may be turned on, and then when the performer possessing the tag 303 moves to the next position, the first camera 304a may be turned off, and the second to fourth cameras 304b, 304c, and 304d covering the positions to which the performer moves may be sequentially turned on, with the fourth camera 304d being turned on when the performer possessing the tag 303 reaches a final position.

The one or more cameras 304a, 304b, 304c, and 304d may be infrared ray cameras, general cameras, etc., and each control unit (not shown) may find a position of the performer possessing the tag 303 and control according to the position.

The system may further include a display unit for displaying images generated from the images obtained by the one or more cameras.

In an embodiment, when a three-dimensional (3D) hologram image is implemented, a hologram object image may automatically track the performer.

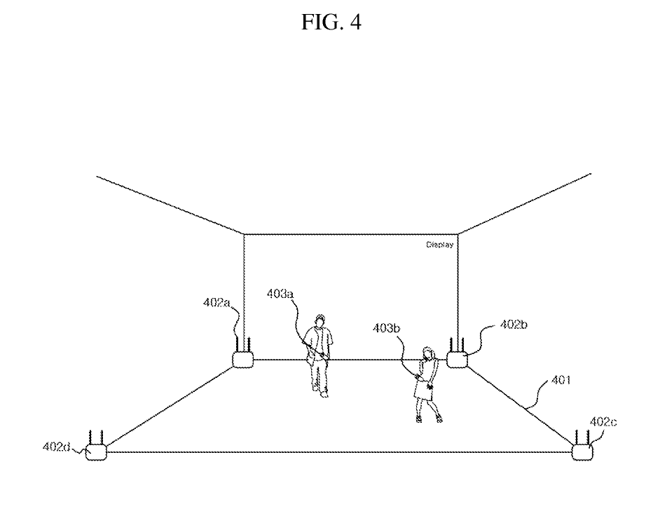

FIG. 4 is a schematic diagram illustrating a performance system according to another embodiment of the present invention.

Referring to FIG. 4, there are one or more performers possessing tags 403a and 403b in one performance venue 401.

When there are the one or more performers possessing tags 403a and 403b, the performers may be identified by the tag IDs of the tags 403a and 403b.

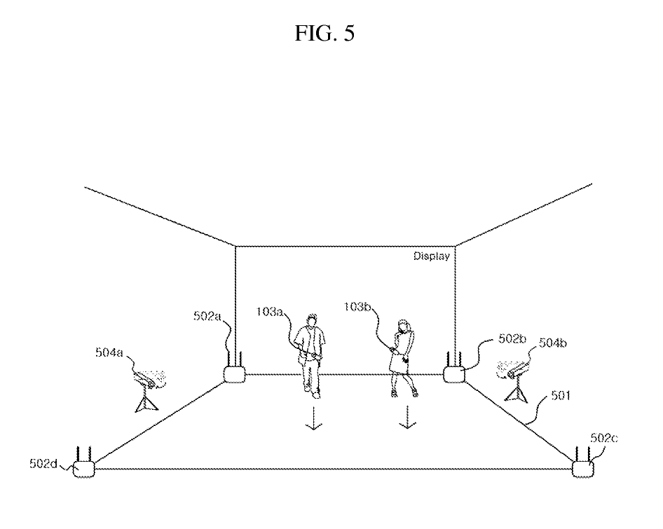

FIG. 5 is a schematic diagram illustrating a performance system according to still another embodiment of the present invention.

Referring to FIG. 5, when the performers possessing two tags 103a and 103b move in the performance venue 501, lighting devices 504a and 504b corresponding to the two tags 103a and 103b, respectively, may track the tags 103a and 103b to which the lighting devices 504a and 504b correspond, respectively.

When there are one or more tags 103a and 103b in one performance venue 501, positions of the performers possessing the tags 103a and 103b may be measured using the tag IDs of the tags 103a and 103b, and the one or more lighting devices 504a and 504b may be controlled using the measured position information.

Even when there are one or more cameras as described above, and even when there are the one or more performers possessing one or more tags as described with reference to FIG. 5, the positions of the tags may be identified by the tag IDs of the tags, and the lighting devices may be controlled according to the identified positions.

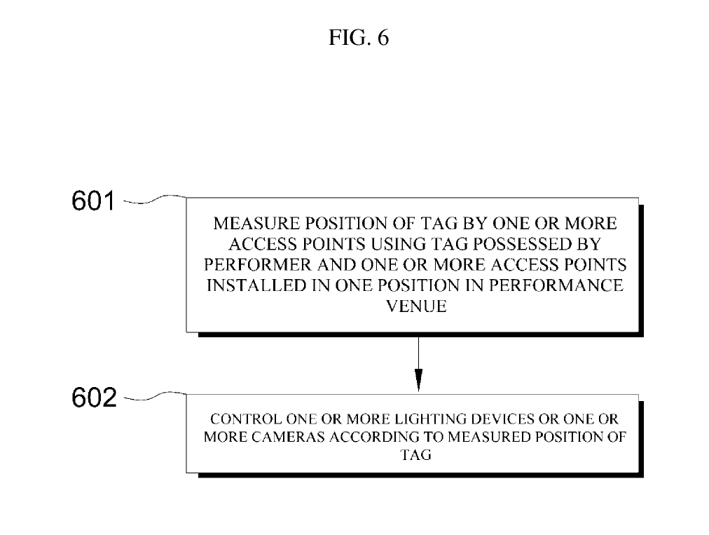

FIG. 6 is a flowchart for describing a performance method according to still another embodiment of the present invention.

Referring to FIG. 6, a real-time locating system (RTLS)-based performance method may include measuring the position of the tag by the one or more access points using the tag possessed by the performer and the one or more access points installed in positions in the performance venue (601).

Further, the method may further include controlling the one or more lighting devices or the one or more cameras according to the measured position of the tag (602).

According to the configuration of the present invention, a much more interactive performance may be implemented by measuring the position of the performer in real time and automatically controlling the lighting and the performing image.

While embodiments of the present invention have been described in detail above, the scope of the present invention is not limited by these exemplary embodiments of the present invention. The scope of the present invention should be defined by the claims, and it is intended that the present invention cover all such modifications and changes those of ordinary skill in the art can derive from the basic concept of the appended claims and their equivalents.

What is claimed is:

1. A real-time locating system (RTLS)-based performance system, comprising:
a tag possessed by a performer; and
one or more access points installed in one position of a performance venue,
wherein a position of the tag is measured by the one or more access points.

2. The RTLS-based performance system of claim 1, further comprising:
one or more lighting devices configured to be controlled according to the position of the performer which is measured by the tag and the one or more access points.

3. The RTLS-based performance system of claim 2, wherein the one or more lighting devices are controlled to perform at least one of a tracking operation, an on/off operation, or a dimming operation.

4. The RTLS-based performance system of claim 1, further comprising:
one or more cameras configured to track the performer according to the position of the performer which is measured using the tag and the one or more access points.

5. The RTLS-based performance system of claim 1, further comprising:
one or more motion recognition cameras configured to recognize a motion of the performer,
wherein one or more of the motion recognition cameras are selected according to the position of the performer which is measured using the tag and the one or more access points.

6. The RTLS-based performance system of claim 4, further comprising:
a display unit configured to display an image generated from images obtained by the one or more cameras or the one or more motion recognition cameras.

7. The RTLS-based performance system of claim 5, further comprising:
a display unit configured to display an image generated from images obtained by the one or more cameras or the one or more motion recognition cameras.

8. The RTLS-based performance system of claim 1, wherein, when the number of performers is one or more, the performers are identified by tag IDs.

9. A real-time locating system (RTLS)-based performance method, comprising:
measuring a position of a tag by one or more access points using the tag possessed by a performer, the one or more access points being installed in one position in a performance venue.
